(19) United States
(12) Patent Application Publication
(10) Pub. No.: US 2019/0346027 A1
(43) Pub. Date: Nov. 14, 2019

(54) SELF-LOCKING LOCK-UP MEANS FOR A CONTINUOUSLY VARIABLE TRANSMISSION SYSTEM

(71) Applicants: Cyril CLOPET, PIREY (FR); Pierre AZZOPARDI, BESANCON (FR)

(72) Inventors: Cyril CLOPET, PIREY (FR); Pierre AZZOPARDI, BESANCON (FR)

(21) Appl. No.: 16/464,722

(22) PCT Filed: Nov. 30, 2017
(86) PCT No.: PCT/FR2017/053321

§ 371 Date: May 29, 2019

(30) Foreign Application Priority Data
Dec. 1, 2016 (FR) 1661789

(51) Int. Cl. F16H 9/24; F16H 9/10

(52) U.S. Cl. CPC F16H 9/24; F16H 55/32; F16H 9/10

(57) ABSTRACT

Self-locking lock-up means (20, 21) for a transmission mechanism (1) comprising at least one wheel and a transmission linkage collaborating with said wheel, the lock-up means comprises at least one lock-up support (22) exhibiting at least one first bearing surface and at least one wedging element (201, 211) comprising:—a second bearing surface collaborating with the first bearing surface,—a lock-up surface (213, 203) able to collaborate temporarily with a driving surface opposite, the wedging element being able to move in a direction of insertion along the first bearing surface between a minimum position in which the lock-up surface is furthest away from the drive surface opposite and a nominal position in which the lock-up surface is in contact with the drive surface.

### TECHNICAL FIELD

The present invention relates to the field of mechanical transmissions with a continuously variable ratio. More particularly, the invention concerns a self-locking gripping means facilitating the engaging and the disengaging of a transmission link portion when it is located in a transitional phase between a strand under tension or loose and a driving or driven wound portion.

### PRIOR ART

From the prior art is known the document FR 11 566 99 describing a rotation power transmission mechanism using self-locking means comprising blocking elements cooperating by jamming between on the one hand a flexible link, extending in a closed loop, and on the other hand a driving or driven wheel.

In this document, the gripping means uses a blocking element constituted of 2 articulated wedges, the first making the jamming connection and the second making a movement perpendicular to the first allowing a play to appear with the transmission chain when the transmission chain approaches it and to bridge this play once the chain reaches a certain position.

A first problem with this solution lies in its complexity and its fragility, as it requires to make two articulated wedges for each blocking element. Another problem is linked with its unidirectional nature as each gripping means can only transmit a force in a single direction and therefore there must be distinct gripping means for transmitting force in both directions, which has a negative impact on the compactness of the transmission.

The objective of the present invention is to propose a simple and robust gripping means that facilitates the engaging and disengaging of a transmission link portion on a wheel and which enables the transmission in both directions for each gripping means.

### DESCRIPTION OF THE INVENTION

To this end, the object of the invention is a self-locking gripping means for a continuously variable transmission mechanism comprising at least one wheel and a transmission link extending in a closed loop and cooperating with said wheel along a wound portion, the transmission link being constituted of a succession of link portions each defining a longitudinal direction L tangent to the closed loop and a normal direction N perpendicular to a longitudinal plane, parallel to the rotation axis of the wheel and to the longitudinal direction. The gripping means being integral with the transmission link or the wheel, it comprises at least a gripping support having at least a first bearing surface and at least one blocking element comprising:
a second bearing surface cooperating with the first bearing surface through a sliding or rolling contact,
a gripping surface suitable capable of cooperating temporarily with a facing driving surface, belonging to the wheel when the gripping means is integral with the transmission link, and belonging to the transmission link when the gripping means is integral with the wheel,
   said blocking element being capable of moving along the first bearing surface at least along one insertion direction comprised in a principal plane passing through the blocking element, said principal plane being parallel to the rotation axis of the wheel and to a principal direction P, which passes through the blocking element, which is radial when the gripping means is integral with the wheel and which is normal when the gripping means is integral with a portion of the link, said movement of the blocking element along the insertion direction has a minimum position in which the gripping surface is the furthest from the facing driving surface and a nominal position in which the gripping surface is in contact with the driving surface, the insertion direction having a non-zero insertion angle in relation to the principal direction.

By insertion angle is understood the angle formed by the trajectory of the blocking element with regard to the principal direction when it is moved along the insertion direction. The presence of this angle allows the gripping surface to have a play in relation to the driving surface, allowing the absence of interference to be guaranteed between the blocking element and the driving surface when a link portion is about to enter in a wound portion. Then, when the blocking element is moved along the insertion direction, the non-zero insertion angle allows the gripping surface and the facing driving surface to come closer and then to come into contact.

The longitudinal direction L is tangential to the closed loop and perpendicular to the axis of the wheel. The normal direction N is perpendicular to the axis of the wheel and to the longitudinal direction.

When the gripping means is integral with the wheel, the radial direction is a radius coming from the axis of the wheel passing through the gripping means.

When the gripping means is located in a wound portion, the normal and radial directions are essentially the same.

The cooperation between the blocking element and the first bearing surface is made, for example, through a sliding or rolling contact.

According to the invention, the gripping means comprises a gripping support and at least one blocking element capable of moving on a bearing surface of said gripping support, said movement allowing passing from a non-gripping position (minimum position) to a gripping position (nominal position) thanks to the existence of the non-zero insertion angle.

This solution thus allows simplifying the making of the gripping means, which may be constituted of a very limited number of parts. Indeed, the movement of a blocking element, which may be constituted of a single rigid assembly, allows the coming into contact function between the link and the wheel to be realised, which allows the complexity of the gripping means to be reduced, in comparison with known solutions from the prior art.

Advantageously, the rolling contact uses rolling means chosen among balls, needles, rollers and cams.

Advantageously, the insertion angle is arranged such that it allows the blocking element, when it is located in a wound portion, to be jammed between the first bearing surface and the driving surface when the driving surface exerts on the facing gripping surface a force whose projection in the normal plane to the rotation axis of the wheel is only along the principal direction.

In the well-known prior art of transmissions by flexible link, equations are known that describe the component along the principal direction of the winding force of a link on a wheel or a sprocket depending on the tension of said link. In the prior art, this component along the principal direction is stopped by an obstacle, such as, for example, by conical flanges in the case of variable ratio transmissions, but this causes significant variation forces. We now consider the theoretical winding of a link on a wheel of the mechanism in which only the component along the principal direction of the winding force would be transmitted by the driving surface to the facing gripping surface. This would be the case, for example, if another device on the link or the wheel such as mechanical obstacles, for example, were capable of transmitting any other component of the winding force which would not be along the principal direction. The insertion angle allows the blocking element, when it is subjected only to the component along the principal direction of the winding force, to be jammed between the driving surface and the first bearing surface, in other words the application of the component along the principal direction on the gripping surface generates an axial pushing force between the gripping surface and the facing driving surface proportional to said component along the principal direction, said axial pushing force creating a friction force between the gripping surface and the facing driving surface, capable of maintaining the mutual immobilisation of these two surfaces whatever the change of said component according to the principal direction. Thus, the fact that the insertion angle is a jamming angle of the blocking element in relation to the component along the principal direction of the winding force allows a portion of the link cooperating with the wheel by means of a blocking element to occupy any radial position of said wheel without discretisation and without the use of conical flanges.

Considering the sliding or rolling coefficient of the blocking element along the first bearing surface to be zero and calling μ the adhesion coefficient of the gripping surface on the facing driving surface, then the condition for the insertion angle α to be a jamming angle of the blocking element in relation to only the component along the principal direction is written:

tan(α)≤μ.

Considering μ=0.1, it is obtained for example that any α≤5.7° will be an insertion angle allowing the jamming of the blocking element when the driving surface exerts on the gripping surface a force whose projection on a plane normal to the axis is only along the principal direction.

Advantageously, the insertion angle is arranged in such a way to allow the blocking element, when it is located in a winding portion, to be jammed between the first bearing surface and the driving surface when the driving surface exerts on the facing gripping surface a force whose projection on a plane normal to the rotation axis of the wheel has a first component along the principal direction and a second component along a secondary direction perpendicular to the principal direction and to the rotation axis of the wheel, said second component having a magnitude changing proportionally to the magnitude of said first component.

When the gripping means is integral with the link, the secondary direction is the same than the longitudinal direction and when the gripping means is integral with the wheel, the secondary direction is perpendicular to the radial direction.

In the prior art of transmission links cooperating with a wheel, equations are known defining the coefficient of proportionality of the component along the principal direction of the winding force in relation to its component along the secondary direction. The coefficient of proportionality depends, for example, on the shape of the wheel. Due to this proportionality, the components along the principal and secondary directions change simultaneously according to the tension of the link. As a result, if the insertion angle is a jamming angle of the blocking element such that, for a component along the principal direction of the winding force exerted by the driving surface on the facing gripping surface, the axial pushing force generated by the gripping surface on the facing driving surface creates a friction force which magnitude is greater than or equal to the magnitude of the winding force, then said insertion angle is a jamming angle of the blocking element for any winding force.

Considering the slipping or rolling coefficient of the blocking element along the first bearing surface as being zero, considering a coefficient of adhesion p of the gripping surface on the facing driving surface and considering a proportionality factor k between the component along the principal direction FP and the component along the secondary direction FS of the winding force such that FS=k×FP then the condition for the holding angle α to be a jamming angle of the blocking element in relation to the winding force is written:

$$tan ( α ) \leq \frac{μ}{\sqrt{( {k}^{2} + 1 )}}$$

Considering μ=0.1 and k=2, for example, it is obtained that any α≤2.6° will thus be an insertion angle allowing the jamming of the blocking element for any winding force exerted by the driving surface on the engaging surface. Furthermore, this insertion angle will also be a jamming angle of the blocking element for any winding force if FS<k×FP.

Due to this feature, the functioning of the gripping means is simplified, since the single movement of a blocking element along the insertion direction may be sufficient to achieve the contact and the transmission of the winding force between a transmission link and a wheel. Moreover, the fact that this function is ensured by the jamming of a blocking element has the advantage that the axial pushing force adjusts itself automatically to the winding force which allows a good transmission efficiency to be reached. In addition, the fact that this is the component along the principal direction of the winding force that causes the jamming of the blocking element for any winding force makes the gripping means bidirectional, in other words, capable of transmitting the winding force component along the secondary direction whether it is in the same or in the opposite direction than the direction of movement of the link.

Advantageously, the blocking element is capable of being moved along the first bearing surface according to a second direction which is a holding direction T comprised in a secondary plane perpendicular to the principal direction, said holding direction having a non-zero holding angle in relation to the secondary direction S.

By holding angle is understood the angle formed by the trajectory of the blocking element with regard to the secondary direction when it is moved along the holding direction. The fact that the secondary movement has a non-zero holding angle causes a movement of the blocking element in the axial direction when the blocking element is driven in the holding direction. This axial movement has the advantage, when the driving or gripping surfaces are worn, of allowing the blocking element to reduce the plays that are created due to this wear, by a movement in a holding direction different from the insertion direction.

Advantageously, the gripping means comprises at least one blocking element capable of being moved at least temporarily along a holding direction and at least one blocking element capable of being moved at least temporarily along a second holding direction essentially symmetrical to said holding direction in relation to a principal plane passing essentially by the centre of the gripping support.

While the transmission is functioning, the direction of the component along the secondary direction of the winding force exerted by the driving surface on the facing gripping surface may be reversed, when the driving wheel becomes driven, for example or even, when the gripping means integral with a portion of the link changes from a driving wheel to a driven wheel. The fact that the gripping means comprises at least one blocking element capable of moving along each of the two holding directions has the advantage that, whatever the direction of the component along the secondary direction, said component along the secondary direction drives at least one blocking element in such a way as to increase the axial push of said blocking element against the facing driving surface.

Advantageously, the gripping means comprises a single blocking element capable of being moved temporarily along each of the two holding directions.

Advantageously, the holding angle is arranged such that it allows the blocking element, when it is located in a wound portion, to be jammed between the first bearing surface and the driving surface when the driving surface exerts on the facing gripping surface a force whose projection on the plane normal to the rotation axis of the wheel is only along the secondary direction.

In the well-known prior art of transmissions by flexible link, equations are known that describe the component along the secondary direction of the winding force of a link on a wheel or a sprocket according to the tension of said link. In the prior art of fixed ratio transmissions, this component along the secondary direction is stopped by sets of teeth but this is only possible with a fixed ratio transmission. We now consider the theoretical winding of a link on a wheel of the mechanism in which only the component along the secondary direction of the winding force would be transmitted by the driving surface to the facing gripping surface. This would be the case, for example, if another device on the link or the wheel such as mechanical obstacles, for example, such as undersides belonging to the blocking element, were capable of transmitting any other component of the winding force which would not be along the secondary direction. The holding angle allows the blocking element, when it is subjected only to the component along the secondary direction of the winding force, to be jammed between the driving surface and the first bearing surface, in other words the application of the component along the secondary direction on the gripping surface generates an axial pushing force between the gripping surface and the facing driving surface proportional to said component along the secondary direction, said axial pushing force creating a friction force between the gripping surface and the facing driving surface, capable of maintaining the mutual immobilisation of these two surfaces whatever the change of said component along the secondary direction. Thus, the fact that the holding angle is a jamming angle of the blocking element in relation to the component along the secondary direction of the winding force allows a link portion cooperating with the wheel by means of a blocking element to occupy any angular position of said wheel without discretisation.

Considering the slipping or rolling coefficient of the blocking element along the first bearing surface as being zero and calling μ the adhesion coefficient of the gripping surface on the facing driving surface, then the condition for the holding angle α to be a jamming angle of the blocking element in relation to the component along the principal direction only is written: tan(β)≤μ.

Considering μ=0.1, it is obtained for example that any β≤5.7° will thus be an insertion angle allowing the jamming of the blocking element when the driving surface exerts on the gripping surface a force whose projection on a plane normal to the axis is only along the secondary direction.

Advantageously, the gripping means comprises at least one blocking element capable of moving along any combination of an insertion direction and a holding direction, the insertion and holding angles being arranged in such a way as to allow the blocking element, when it is located in a wound portion to be jammed between a first bearing surface and a driving surface when the driving surface exerts on the facing gripping surface a force whose projection on a plane normal to the rotation axis of the wheel has a component along the principal direction and a component along the secondary direction.

This feature provides the advantage that, when one link portion cooperates with a wheel of the mechanism by means of a blocking element, the jamming of said blocking element may be obtained with insertion and holding angles higher than if the movement of the blocking element had taken place only along the insertion direction. Indeed, considering the coefficient of friction between the first and second bearing surface as being zero, by calling β the coefficient of adhesion of the gripping surface onto the facing driving surface and considering α=β and μ=0.1 for example, then the condition for the insertion angle α and the holding angle β to be jamming angles of the blocking element in relation to the winding force is α, β≤4.3° and that condition is valid for any winding force whose direction is comprised between the secondary direction and the principal direction.

Advantageously, the holding angle β is arranged in such a way as to allow the blocking element, when it is located in a wound portion, to be jammed between the first bearing surface and the driving surface when the driving surface exerts on the facing gripping surface a force whose projection on a plane normal to the rotation axis of the wheel has a first component along the principal direction and a second component along a secondary direction, said second component having a magnitude changing proportionally to the magnitude of said first component.

Advantageously, the transmission mechanism (1) comprises at least one gripping means and at least one return means capable of moving the blocking element to the minimum position.

The return means may, for example, be chosen among springs, elastic bands, external actions such as the action of a cam, a centrifugal force or an electromagnetic motor. The fact that the gripping means comprises a return means of the blocking element to its minimum position provides the advantage, when the gripping means is not located in a wound portion, of guaranteeing the fact that said blocking element cannot interfere with a driving surface.

Advantageously, the transmission mechanism comprises at least an actuating means capable of moving the blocking element to the nominal position.

This actuating means provides the advantage of connecting the blocking element and the facing driving surface when it is necessary for the functioning of the transmission, such as, for example, when a link portion is to enter into a wound portion.

Advantageously, the gripping support is able to move radially along a groove belonging to a flange of a wheel.

The mobility of said gripping support provides the advantage of moving the blocking element in such a way as to allow the link to cooperate with the wheel on a winding radius of a variable diameter.

Advantageously, the actuating means is an actuating shoe which is linked to the blocking element and which is intended to cooperate with the transmission link when the gripping means is integral with a flange of a wheel and which is intended to cooperate with a wheel when the gripping means is integral with a portion of the link.

Thus, when the link rests on the shoe due to its winding force having a component along the principal direction, it drives the blocking element towards its nominal position. This shoe thus achieves an actuating means of the blocking element synchronised with the winding of the link on the wheel.

Advantageously, the actuating means comprises an actuating pad linked to the blocking element and an actuating cam cooperating with said actuating pad, the actuating cam being integral with an articulating mover.

The fact that the actuation of the blocking element is achieved by a cam provides the advantage of allowing the progressivity of said actuation to be chosen thanks to the geometry of the cam. Furthermore, the actuating cam may also achieve an orientation function of the blocking element when this is located on a link portion. The fact that the cam is integral with an articulating mover enables an orientation of the actuating cam in relation to the link strand entering into the wound portion.

Advantageously, the articulating mover is capable of rotating about a rotation axis of a wheel and has a means of angular positioning at least in relation to the link strand of the transmission, comprising the link portions which, in the direction of movement of the transmission link will cooperate with said wheel.

The fact that the articulating mover is able to move in rotation about the rotation axis and that its position is defined by a roller in contact with the link strand entering into the wheel provides the advantage of synchronising the actuating cam in relation to said strand. Furthermore, the adjustable length rod allows the cam to be offset at an angle in relation to the strand. This offset may be useful for regulating the transmission or to allow a variation of the reduction ratio in the event that the gripping means is integral with the wheel and that its blocking element cooperates with the actuating cam.

Advantageously, the actuating cam is linked to the articulating mover by an actuator capable of changing the radial position of the actuating cam.

This provides the advantage, when the gripping means is located on a portion of the link, of allowing a variation of the winding radius of said link portion by a change of the radial position of the actuating cam.

Advantageously, the actuating means comprises a cable forming a closed loop circulating in grooves belonging to several blocking elements and it also comprises actuating rollers linked to an articulating mover by means of an actuator capable of changing the radial position of said actuating rollers, said rollers being capable of cooperating with the cable or with the blocking elements.

This cable in a closed loop has the advantage, when the gripping means is used on a transmission actuating at high speed, of supporting centrifugal forces of blocking elements while having a relatively low or zero speed relatively to said blocking elements. The actuating rollers give the cable a trajectory making it capable of acting upon the blocking elements when they enter into a wound portion.

Advantageously, the gripping means is integral with a transmission link or cooperates with a transmission link comprising a first set of first chain links cooperating with the wheel by means of gripping means and a second set of second chain links mutually-articulated in a link forming a closed loop, each chain link of a set comprising a receiving slot and each chain link of the other set comprising an engagement rod cooperating with the receiving slot by a meshed connection enabling a mobility of the second chain links in relation to the first chain links at least along a longitudinal direction.

The fact that first chain links non-integral with the second chain links cooperate with the wheel by means of gripping means provides the advantage that, even if the gripping means provide a temporary rigid connection between the first chain links and the wheel, the second chain links remain capable of being moved in the longitudinal direction by pushing on the first chain links. Thus, the tensions existing between two second chain links may decrease or increase naturally when they are in a driving or receiving winding. Furthermore, the shape of the walls of the receiving slot on which the engagement rod pushes defines the coefficient of proportionality k existing between the projection of the winding force along the principal direction FP and the projection of the winding force along the secondary direction FS such that FS=k×FP.

According to an embodiment, the transmission mechanism may comprise gripping means different from each other or gripping means that are similar.

### BRIEF DESCRIPTION OF THE FIGURES

Other features and/or advantages will appear on reading the following description of the preferred embodiments, given as non-limiting examples, in relation to the attached drawings, among which:

FIG. 1 shows a general view of a transmission mechanism comprising gripping means integral with the transmission link;

FIG. 2 to FIG. 4 show a couple of gripping means according to the embodiment of FIG. 1;

FIG. 5 and FIG. 6 show two variations of the gripping means of FIG. 2. to FIG. 4;

FIG. 7 to FIG. 9 show another variation of the gripping means of FIG. 2. to FIG. 4;

FIG. 10 shows a cross-sectional view along a plane perpendicular to the rotation axis of a wheel of a transmission mechanism comprising gripping means according to the invention, integral with said wheel;

FIG. 11 shows a zoomed cross-sectional view of two gripping means of FIG. 10;

FIG. 12 and FIG. 13 show a variation of the embodiment of FIG. 10 and FIG. 11;

FIG. 14 to FIG. 25 show other variations of the gripping means according to the invention;

FIG. 26 shows a cut-away general view of a transmission mechanism comprising gripping means integral with the transmission link as well as an actuating cable.

FIG. 27 shows a detailed view according to the circle XXVII that can be seen in FIG. 26 of the gripping means of FIG. 26.

### DETAILED DESCRIPTION

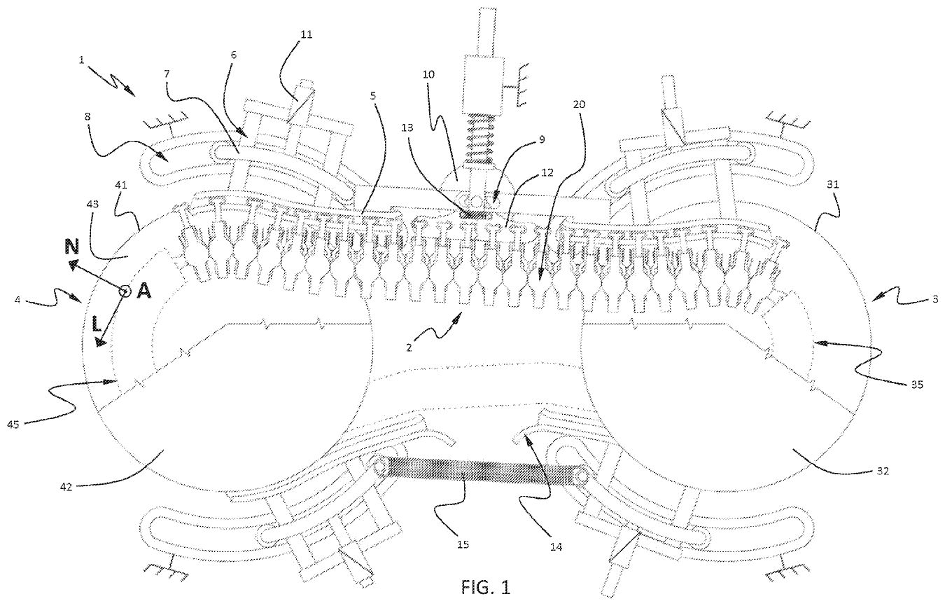

FIG. 1 shows a front view of a continuously variable transmission mechanism 1 comprising gripping means 20 according to a first embodiment of the invention.

In this embodiment, the transmission link 2 is a chain in which each chain link comprises a gripping means 20 and is capable of cooperating with two wheels 3, 4 along the wound portion 35, 45.

On the example of FIG. 1, both wound portions 35, 45 have a continuously variable diameter.

The arrows L, A, N respectively represent the longitudinal direction L, which corresponds to the direction tangent to the transmission link; the axial direction A, which corresponds to any direction parallel to the rotation axis of the wheels 3, 4; and the normal direction N, which corresponds to the direction perpendicular to the longitudinal direction L and to the axial direction A.

In another not shown embodiment, only one wheel of the mechanism has a wound portion of a variable diameter, a tensioning roller compensating the variations of length of the strands of the transmission link 2.

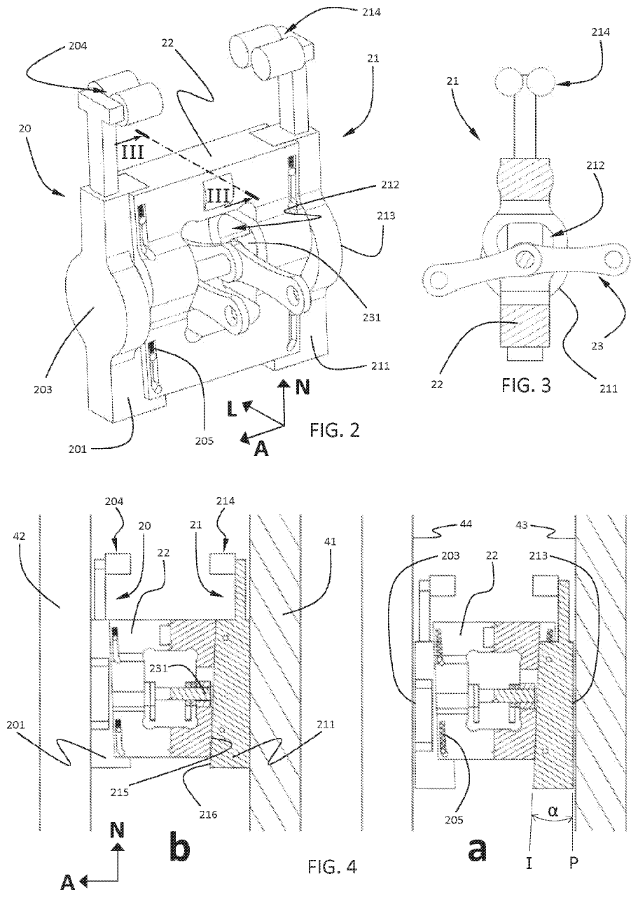

FIG. 2 shows an isometric view of two gripping means 20, 21 according to the embodiment of FIG. 1 located on both sides of the link, interconnected by their gripping support 22 which is common and rigid in compression in the axial direction A. This gripping support 22 constitutes a chain link of the transmission link 2, it comprises a receiving slot 212 intended to cooperate with an engagement rod 231 of a pulling chain link 23 capable of being articulated with other pulling chain links 23 to form a transmission link in a closed loop. The shape of the receiving slot 212 defines the coefficient of proportionality k existing between the component along the principal direction FP of the winding force and the component along the secondary direction FS of the winding force, such that FS=k×FP. Each gripping means 20, 21 also comprises a blocking element 201, 211 cooperating with the gripping support 22, each of the blocking elements 201, 211 being linked to actuating pads 204, 214.

FIG. 3 is a cross-section along the axis III-III of FIG. 2. FIG. 4 illustrates a couple of gripping means 20, 21 of FIG. 2 in a cut-away view in two positions a, b, as they cooperate with the wheel 4. Both wheels 3 and 4 functionning in an essentially similar way, only the description of the cooperateion of the gripping means 20, 21 with wheel 4 is described. The functioning details given here for the gripping means 21 are also valid for the gripping means 20 which is symmetrical and functions in a similar way. The gripping support 22 has a first bearing surface 215 cooperating with a facing second bearing surface 216 belonging to the blocking element 211.

The blocking element 211 has a gripping surface 213 and is arranged with the gripping support 22 in such a way that its second bearing surface 216 slides along the first bearing surface 215 to go from the minimum position a in which the gripping surface 213 is at a distance from the driving surface 43 of the flange 41, to the nominal position b in which the gripping surface 213 and the driving surface 43 are in contact.

This movement is along the insertion direction I and has a non-zero insertion angle α in relation to a principal direction P as illustrated in FIG. 4. As the gripping means 20, 21 are integral with a link portion, the principal direction is the same than the normal direction which is perpendicular to the rotation axis of the wheel 3, 4 and to the longitudinal direction tangent to the closed loop at the location of the link portion comprising the gripping means 20, 21. In FIG. 4, when the blocking elements 201, 211 are in the position b, the gripping means 20, 21 are located in a wound portion and the principal direction is therefore also the same than the radial direction.

Advantageously, the insertion angle α is arranged in such a way as to allow the blocking element 211 to be jammed between the driving surface 43 and the first bearing surface 215 for a winding force comprising a component along the principal direction Fp and a component along the secondary direction Fs proportional to the component along the principal direction such that Fs=k×Fp.

For k−2 and μ−0.1, a will have to be lower than 2.6°. By using specific coatings, it is possible to obtain a high coefficient of adhesion μ between the gripping surface and the facing driving surface, which allows the insertion angle α to be increased.

The fact that the gripping means 20, 21 are located on each sides of the link and each cooperate with a flange 42, 41 allows the component along the axial direction A of the force exerted by the blocking element 211 on the gripping support 22 to be balanced by an essentially identical component exerted by the blocking element 201 on the gripping support 22. Another advantage is that the winding force exerted by the engagement rod 231 on the gripping support 22 is transmitted from the transmission link 2 to the wheel 4 by means of two gripping means 20, 21 which essentially halves the forces exerted on the elements constituting said two gripping means 20, 21.

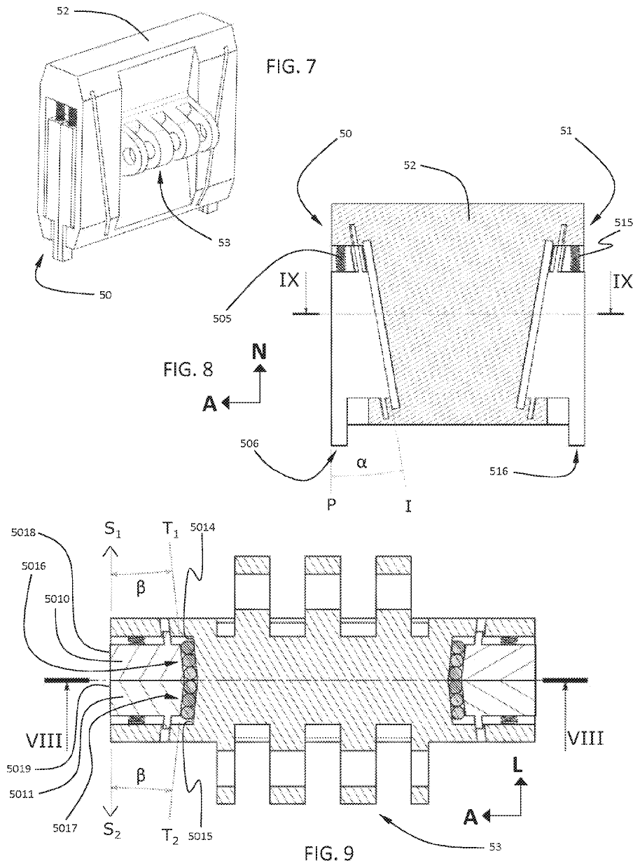

In this embodiment, the movement of the blocking element 211 occurs only along the insertion direction and is not possible along a holding direction, contrary to the embodiment shown in FIG. 7 to FIG. 9, for example.

The blocking elements 201, 211 are pushed towards the minimum position a by return means 205, such as springs.

The actuating pads 204, 214 cooperate with actuating cams 5, visible on FIG. 1, to drive the blocking elements 201, 211 from the minimum position a to the nominal position b.

Advantageously, the actuating cam 5 is also an orientation cam that defines the orientation of the blocking elements 201, 211.

In the embodiment of FIG. 1, each actuation cam 5 is fastened rigidly to cam rods 6 which are in sliding connection with an articulating mover 7, able to move in an articulation path 8, concentric to the rotation axis of a wheel 3, 4. Thus, each actuating cam 5 is capable of rotating about the axis of a wheel 3, 4.

The actuating cam 5 is supported by means of an oblong groove 9 by a tensioning roller 10 in contact with a strand of the transmission link 2, which has the effect of defining the orientation of the actuating cam 5 relatively to a strand of the transmission link 2. The oblong groove 9 and the tensioning roller 10 thus constitute a means of angular positioning of the actuating cam 5 relatively to the strand of the transmission link 2 entering the wheel 3, 4. In another embodiment not shown, this means of angular positioning may for example be constituted of a motor equipped with sensors.

In a shown variation on the second strand of the transmission link 2 shown in FIG. 1, the actuating cam comprises a circular outlet 14 which is put in contact with the transmission link 2 by a tensioning spring 15 being supported by the supporting frame or on another actuating cam. This allows the actuating cam 5 to provide itself the tension of the transmission link 2, without the need for an additional roller.

In order to change the winding radius of the chain, a control actuator 11 acts upon the cam rods 6, changing their position relatively to the articulation mover 7 which has the effect of moving the actuating cam 5 essentially radially. The control actuator 11 is therefore an actuator capable of changing the radial position of the actuating cam 5. Advantageously, in a not shown embodiment, the movement of the actuating cam 5 driven by the control actuator 11 follows a different curve according to a radius that optimises the positioning of the blocking elements 201, 211 when they cooperate with the wheels 3, 4.

Advantageously, the flanges 31, 32, 41, 42 are plane disks, the blocking elements 201, 211 in minimum position allow the transmission link 2 to circulate without interference between two facing flanges 31, 32, 41, 42 and the actuating cams 5 cooperating with the actuating pads 204, 214 allow a movement of the blocking elements 201, 211 along an insertion direction up to the nominal position in which the gripping surfaces 203, 213 come into contact with the driving surfaces of facing flanges 31, 32, 41, 42. The actuating cams 5 and the actuating pad 204, 214 therefore constitute an actuating means capable of driving the blocking element 201, 211 towards the nominal position.

When functioning, the tensioned strand of the transmission link 2 may be reversed, for example when a driving wheel becomes driven.

To ensure good cooperation between the tensioning roller 10 and the strand of the link, whether tensioned or not, two supporting pads 12 are mounted pivoting around the axis of the tensioning roller 10. These supporting pads 12 are pressed against the transmission link 2 by means of a pad spring 13, which has the effect of limiting the vibrations of the tensioning roller 10 when the strand changes in an essentially straight line.

In the example of FIG. 5, in order to minimise the friction losses when the blocking element 301 cooperates with the actuating cam 5, the actuating pad 304 may be constituted of rollers 3041. Furthermore, when a blocking element cooperates with a wheel 3, 4 a phase may occur during which it is also in contact with an actuating cam 5. The actuating pad 304 and the actuating cam 5 therefore constitute an actuating means capable of driving the blocking element 301 along an insertion direction towards to the nominal position. In order to overcome any manufacturing faults or faults in positioning the actuating cam 5, the blocking element may be connected to an actuating pad 304 by means of a flexible element 3042 such as an elastomer or a spring.

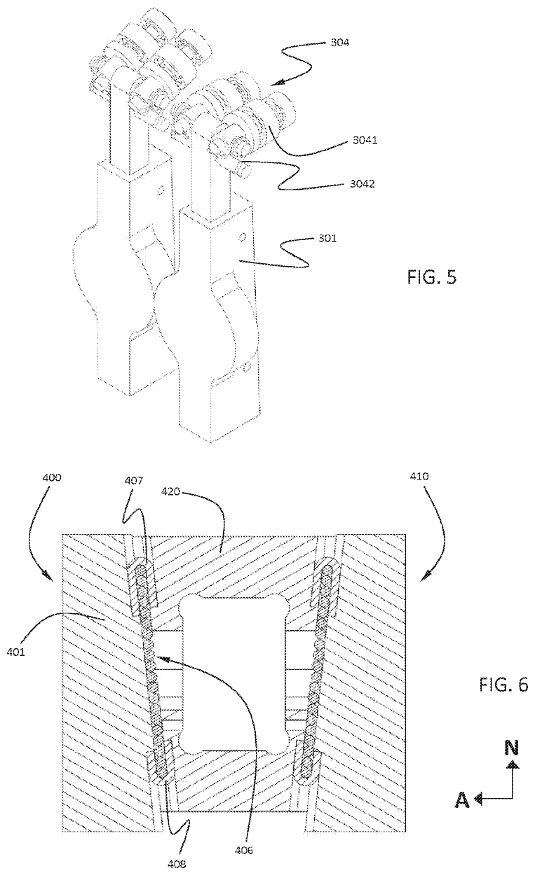

The gripping means of FIGS. 6, 7 to 9, 14 to 17, 18 and 20 to 21 have blocking elements 401, 5010, 5011, 801, 811, 901, 911, 1101, 1111 capable of cooperating with flanges 41, 42 that are planar discs and have driving surfaces 43, 44 as is the case for the wheel 4, for example. For the sake of clarity, these flanges 41, 42 are not shown on these figures. In other not shown embodiments, the flanges may not be planar and have, for example, a conical shape.

FIG. 6 illustrates a partial cross-sectional view of a variation of the embodiment of FIGS. 2 to 4 on which the pulling chain link is not shown for simplicity. In FIG. 6, two symmetrical gripping means 400, 410 are connected by means of their gripping support 420. Only the functioning of the gripping means 400 will be detailed, the gripping means 410 functioning in a similar way. The only difference in relation to the gripping means of FIGS. 2 to 4 is in the fact that the gripping means 400 comprises a blocking element 401 which is not sliding on the gripping support 420 but rolling on a series of needles 406. In other variations, the needles 406 may be replaced by balls or rollers. In order to synchronise the movement of needles 406 and the blocking element 401, the needles 406 may be contained in segments of rope 407, 408 or of belt or cable, one end of which is connected to the blocking element 401 and the other end of which is connected to the gripping support 420. In another not shown variation, the synchronisation of the rolling elements is provided by a sprocket in pivoting connection on a cage comprising the rolling elements, said sprocket engaging on the one hand on a rack belonging to the blocking element and on the other hand on a rack belonging to the gripping support.

FIG. 7 to FIG. 9 represent a second embodiment of the invention in which the gripping means 50, 51 are interconnected by their gripping support 52 which is common to them and rigidly connected to the articulation plates 53 capable of being articulated with the articulation plates 53 of other neighbouring gripping supports 52 to form a link in a closed loop comprising the gripping means 50, 51.

FIG. 8 shows a cross section along the principal plane VIII-VIII passing through the centre of the gripping means 50, 51 shown on FIG. 9.

FIG. 9 shows a cross-section along the secondary plane IX-IX shown in FIG. 8.

As the gripping means 50, 51 are symmetrical, only the functioning of the gripping means 50 is given, the gripping means 51 functioning in a similar way. The gripping means 50 comprises two blocking elements 5010, 5011 each of which showing a gripping surface 5018, 5019 capable of coming into contact with a driving surface 43, 44 of a flange 41, 42 not shown, said blocking elements 5101, 5011 being capable of sliding along the insertion direction I, and each of them being capable of rolling along a holding direction T1, T2, for example on the needles 5016, 5017 being supported by a first bearing surface 5014, 5015. The first bearing surface 5015 being a symmetry of the first bearing surface 5014 according to the principal plane VIII passing through the centre of the gripping means 50. The holding direction T2 also being a symmetry of the holding direction T1 relatively to the same principal plane VIII.

The insertion direction I has an insertion angle α relatively to the principal direction P and the holding directions T1, T2 each have a holding angle β relatively to the secondary direction S essentially the same than S1 and S2.

Advantageously, the insertion angle α and the holding angle β are arranged in such a way as to allow the blocking element 5010 to be jammed for a winding force having a direction between the secondary direction in the direction S1 and the principal direction P, the second blocking element 5011 being jammed for a winding force having its direction between the secondary direction in the direction S2 and the principal direction P. Furthermore, each gripping means 50, 51 comprises actuating shoes 506, 516 integral with the blocking elements allowing a not shown mandrel integral with the wheel 4 to move the blocking elements along the insertion direction I towards a nominal position. The shoe 506 thus constitutes an actuating means capable of driving the blocking elements 5010, 5011 along an insertion direction towards the nominal position. Each gripping means 50, 51 also comprises return means 505, 515 allowing the blocking elements to be brought back to the minimum position.

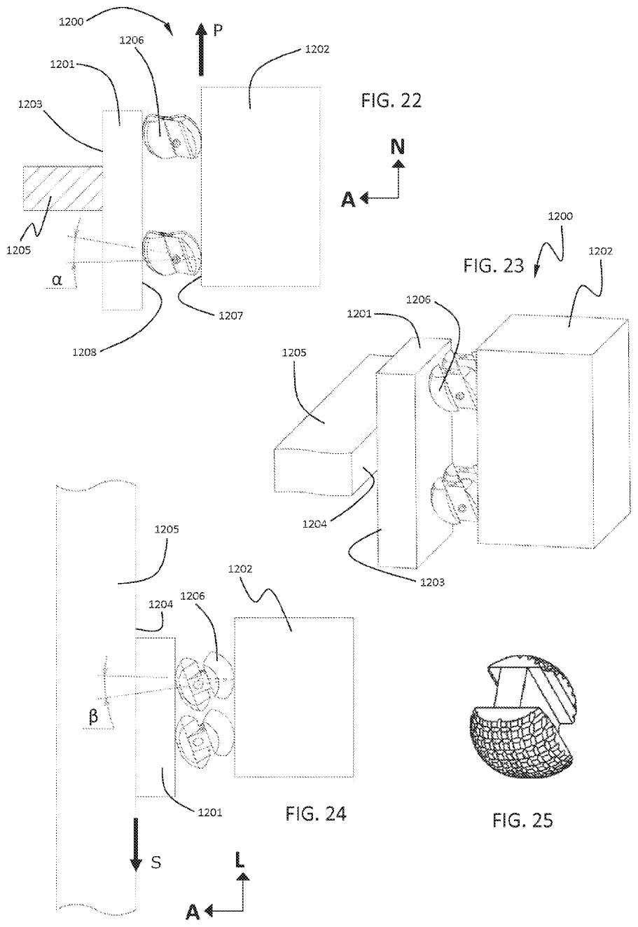

In this variation, the gripping means 50 uses two blocking elements 5010, 5011 each cooperating with a first bearing surface 5014, 5015 symmetrical to the other first bearing surface 5014, 5015 and each one capable of moving in the secondary plane along a single holding direction T1 or T2. In another variation such as that of FIGS. 22 to 25, each gripping means uses a single blocking element capable of moving alternatively along either of the holding directions T1, T2.

In another variation not shown, the needles 5016, 5017 are replaced by balls, allowing the blocking elements 5010, 5011 to roll in the insertion direction I and along the holding direction T1, T2.

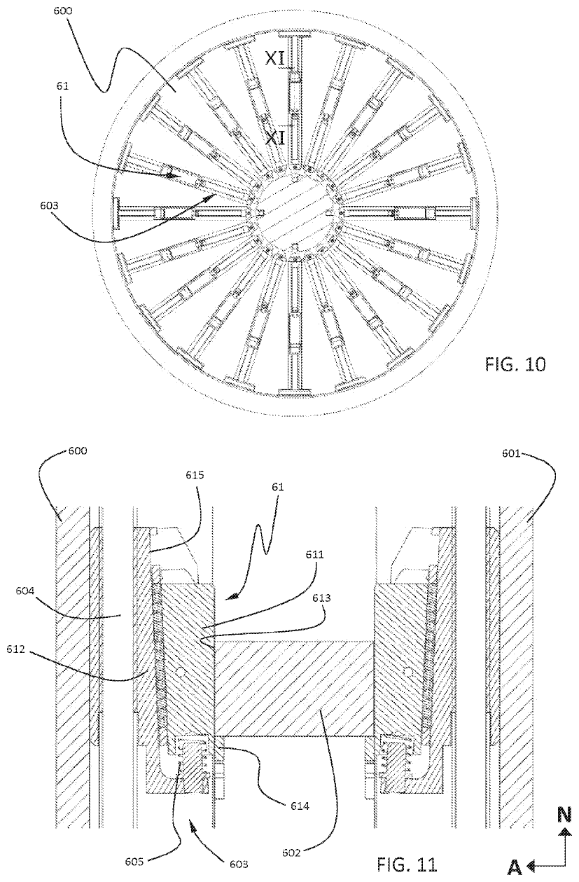

FIG. 10 is a cross-sectional view along a plane perpendicular to the rotation axis of a wheel and passing between two flanges 600, 601 of said wheel which shows another embodiment of the invention in which a plurality of gripping means 61 is integral with a flange 600 of a wheel. For the sake of clarity, the transmission link 602 is not shown in FIG. 10.

FIG. 11 is a partial view of a cross-section along the axis XI-XI of FIG. 10. As can be seen in this FIG. 11, each gripping means 61 comprises a gripping support 612 radially movable in a groove 603 belonging to the flange 600. Said gripping support 612 cooperates with a variation actuator 604 integral with the flange 600, capable of changing the radial position of said gripping support 612.

The blocking element 611 is driven towards the nominal position when the transmission link 602 pushes on the actuating shoe 614 and returns to the minimum position thanks to the return means 605 which is a spring supported by the gripping support 612. The actuating shoe 614 therefore constitutes an actuating means capable of moving the blocking element 611 along an insertion direction towards the nominal position.

As shown in FIG. 10, each gripping means 61 integral with the flange 600 is located facing a gripping means integral with the flange 601. In another not shown embodiment, the flange 601 facing the flange 600 is a smooth disc.

Advantageously, the insertion angle α is arranged in such a way as to allow the blocking element 611 to be jammed between the driving surface 613 of the transmission link 602 and the first bearing surface 615 of a gripping support 612 for a winding force comprising a component along the principal direction Fp and a component along the secondary direction Fs proportional to the component along the principal direction such that Fs=k×Fp. This will correspond, for μ=0.1 and k=2 to α≤2.6°.

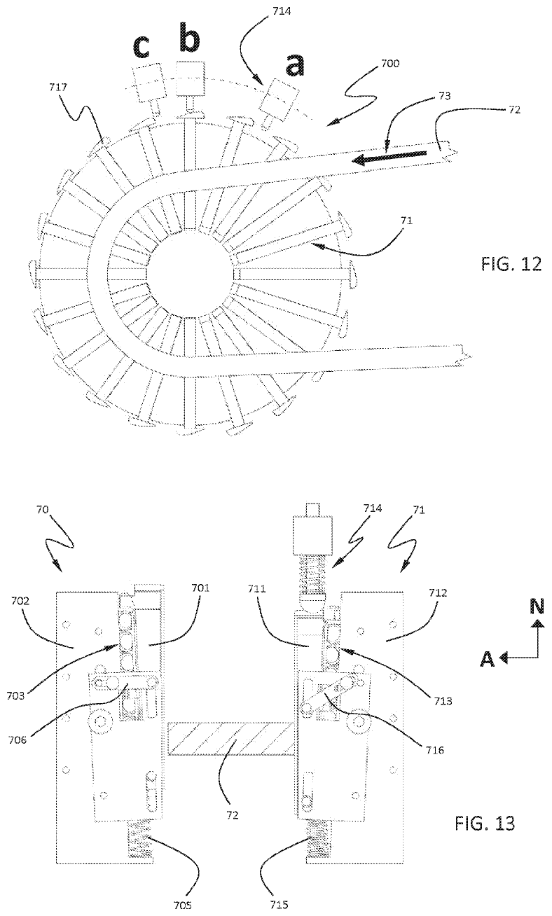

FIG. 12 and FIG. 13 illustrate a variation of the embodiment of FIGS. 10 and 11, in which the gripping means 70, 71 are integral with a wheel 700. FIG. 12 is a simplified schematic view showing a flange of the wheel 700. As shown on FIGS. 12 and 13, each gripping means 70, 71 comprises a gripping support 702, 712, as well as a blocking element 701, 711 comprising an actuating pad 717 capable of cooperating with an actuating cam 714. This actuating cam 714 is integral with a not shown articulation mover which is capable of pivoting about the rotation axis of the wheel 700. Each of the gripping supports 702, 712 are fixed relatively to a flange of the wheel 700 which is not shown in FIG. 13. Each of the blocking elements 701, 711 have a dimension along the principal direction essentially equal to the difference between the maximum and minimum winding radii of the transmission link 72 on the wheel 700.

The blocking element 701, 711 is pushed towards the minimum position by a return means 705, 715 and is capable of cooperating temporarily with an actuating cam 714 integral with the supporting frame which drives it towards the nominal position. The actuating cam 714 as well as the actuating pad 717 therefore constitute an actuating means capable of driving the blocking element 701, 711 along an insertion direction towards a nominal position. In the embodiment of FIGS. 12 and 13, the actuating cam 714 is an isolated roller cooperating with the actuating pad 717 during a short angular portion. In another not shown embodiment, the actuating cam is capable of cooperating with a blocking element during a much greater angular portion.

When the angular position of the actuating cam 714 in relation to the strand of the transmission link 72 entering into the wheel 700 is changed, in other words the strand comprising the portions of the link which, in the direction of movement of the link indicated by the arrow 73 will cooperate with the wheel 700, the radius at which the blocking element cooperates with the transmission link 72 is also changed.

Indeed, the more the angle of rotation travelled by the wheel 700 between the moment where the gripping means 71 is facing a portion of the transmission link 72 and that where it is facing the actuating cam 714 is small, the more the winding radius of the portion of the link facing the gripping means 71 increases. Thus, when the actuating cam 714 is located in the position a, the winding radius is maximum and when it is in the position c, the winding radius is minimum. The position b of the actuating cam 714 corresponds to the winding radius of the link such as it is shown in FIG. 12.

In FIG. 13, the blocking element 701 is shown in minimum position while the blocking element 711 is shown in nominal position, pushed by the actuating cam 714.

Advantageously, the blocking element 701, 711 may be rolling on the rolling elements 703, 711 in relation to the first bearing surface.

So as to synchronise the movement of the rolling elements 703, 713 and of the blocking element 701, 711, the latter is connected to the gripping support 702, 712 by a synchronising arm 706, 716 which rests on a cage containing the rolling elements 703, 713.

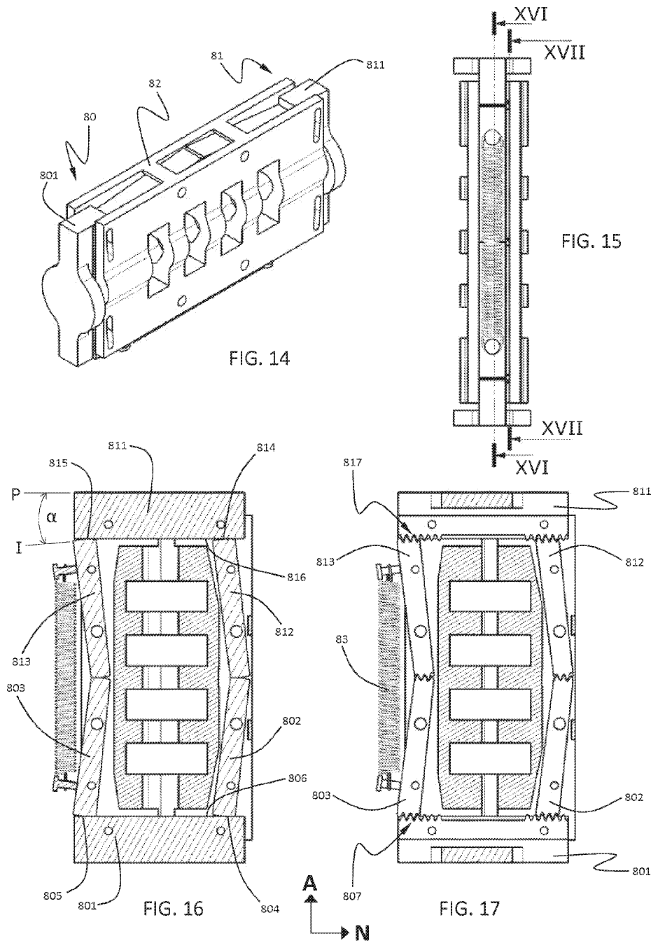

FIG. 14 to FIG. 21 show various embodiments of gripping means integral with a portion of the transmission link. For the sake of clarity, the pulling chain links, the actuating means and in certain cases the return means of the blocking elements are not shown. These elements may be similar to those used in the embodiment of FIGS. 1 to 5, for example.

FIG. 14 shows an isometric view of two gripping means 80, 81 according to another variation of the embodiment shown in FIGS. 2 to 4. FIG. 15 is a bottom view of the two gripping means 80, 81 of FIG. 14. FIGS. 16 to 17 are cross-sectional views along the axes XVI-XVI and XVII-XVII of FIG. 15 respectively.

In this embodiment, the gripping means 80, 81 are part of a transmission link portion. They comprise a gripping support 82 which is common and each one comprises a blocking element 801 and 811. The movement of each blocking element 801, 811 is only along the insertion direction I.

In this variation, the gripping support 82 comprises a receiving slot intended to cooperate with a not shown pulling chain link.

Cams 802, 803, 812, 813 allow a rolling link to be achieved with two blocking elements 801, 811. The profile of said cams 802, 803, 812, 813 may be allowed to have a variable insertion angle a when the blocking elements 801 and 811 are moved along the insertion direction. The insertion angle α may, for example, vary between 5° and 2.6° while the coefficient of adhesion μ between the gripping surface of the blocking element 801 and the facing driving surface is equal to 0.1. This variation allows the play between the gripping surface and the driving surface to be increased thanks to a high insertion angle α when the gripping means is not located in a wound portion and for the jamming conditions of the blocking element to be respected thanks to a smaller insertion angle α when it is pushed towards its nominal position when entering into a wound portion.

As this can be seen in FIG. 16, in this variation, the first bearing surfaces 804, 805, 814, 815 of cams 802, 803, 812, 813 are in contact with the second bearing surfaces 806, 816 of the blocking elements 801, 811. Moreover, cams 802 and 812; 803 and 813 are in contact with each other.

FIG. 17 shows sets of teeth 807, 817 achieved in a second plane, belonging to each cam 802, 803, 812, 813 as well as to the blocking elements 801, 811 which allow said cams and said blocking elements to be synchronised.

Moreover, sets of teeth 807, 817 also allow a return means common to the blocking elements 801, 811 of the two gripping means 80, 81 to be achieved by means of a spring 83 acting directly on the cams, 803, 813. The sets of teeth 807, 817 and the spring 83 thus constitute a return means of the blocking elements 801, 811 towards a minimum position.

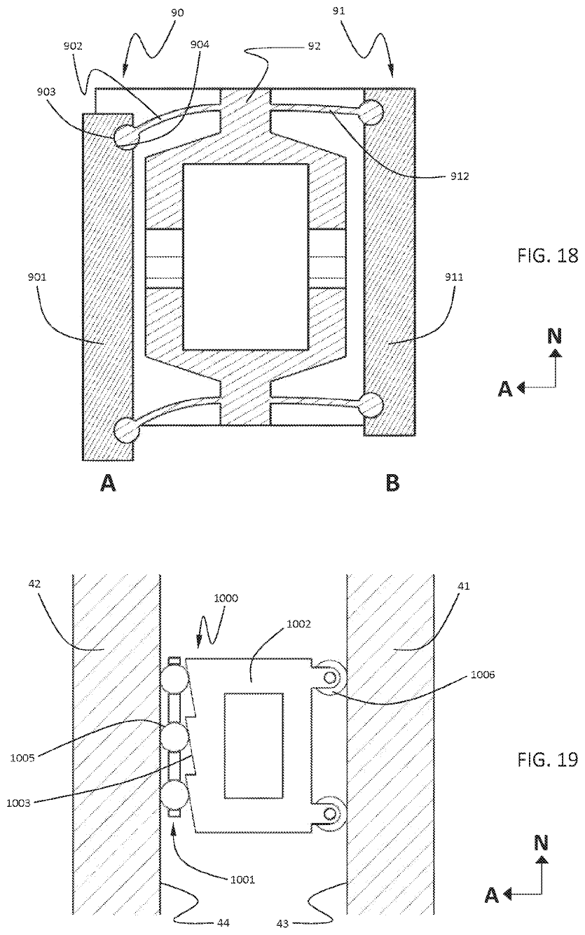

FIG. 18 shows a cross-sectional view according to a principal plane of two gripping means 90, 91 according to another embodiment, integral with a portion of the link. For the purposes of illustration, the gripping means 90 is shown with a blocking element 901 in minimum position and the gripping means 91 is shown with a blocking element 911 in nominal position. The gripping means 90, 91 are linked by their gripping support 92.

In this embodiment, the movement of blocking elements 901, 911 is along the insertion direction. The blocking elements 901, 911 are located on spring blades 902, 912 which ensure the movement of the blocking element 901, 911 by elastic deformation and also constitute the return means of the blocking element 901, 911 to the minimum position. References 903 and 904 respectively designate the first and second bearing surfaces.

FIG. 19 shows a gripping means 1000 according to another embodiment of the invention, integral with a portion of the link. The gripping means 1000 comprises a gripping support 1002 capable of cooperating with a not shown pulling chain link and a blocking element 1001 constituted of a succession of rolling elements such as balls or rollers or needles capable of rolling on the first support surfaces 1003 and of cooperating with a driving surface 44 of a flange 42. The gripping surface 1005 is formed by the surface of the rolling elements and is the same than the second bearing surface. In this embodiment, a single gripping means 1000 equips the portion of the link and the gripping support 1002 comprises response pads or rollers 1006 capable of cooperating with the driving surface 43 of the flange 41, said response rollers 1006 essentially balance the axial forces exerted by the blocking element 1001 on the gripping support 1002.

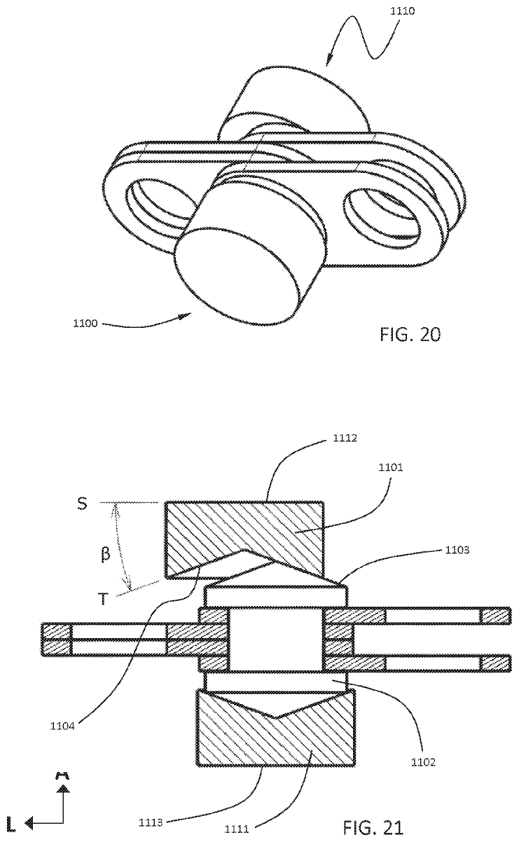

FIG. 20 and FIG. 21 show another embodiment of the invention. In this embodiment, two gripping means 1100, 1110 are integral with a portion of the transmission link and are interconnected by their gripping support 1102 and each comprise a blocking element 1101, 1111 having a gripping surface 1112, 1113 capable of entering into contact with a driving surface 43, 44 of a not shown flange 41, 42. The gripping means 1100 and 1110 being symmetrical and functioning in a similar way, only the functioning of the gripping means 1100 is detailed. The first bearing surface 1103 of the gripping support 1102 and the second bearing surface 1104 of the blocking element 1101 are two mutually cooperating complementary cones. Due to the conical shape of the first and second bearing surfaces 1103 and 1104, the blocking element 1101 may move along the first bearing surface 1103 along the insertion direction I and along the holding direction T or along any direction combining the insertion and holding directions. The insertion angle and the holding angle β are equal and are jamming angles of the blocking element 1101 for any winding force exerted on the engaging surface of the blocking element 1101.

FIGS. 22 to 25 illustrate another embodiment of the invention in which the gripping means 1200 are integral with a flange of a wheel. For the sake of clarity, the return means of the blocking elements at nominal position, the flanges of the wheel and the actuating means towards the nominal position are not shown. These elements may, for example, be similar to those presented in FIGS. 10 to 13. In the same way, for the sake of clarity, the articulation arms allowing the blocking element to be held facing the gripping support are not shown. As the isometric view of FIG. 23 shows, the gripping means 1200 comprises a gripping support 1202 and a blocking element 1201 presenting a gripping surface 1203 facing a driving surface 1204 of the transmission link 1205.

Supporting cams 1206 are arranged between the gripping support 1202 and the blocking element 1201.

In this embodiment, the portion of the supporting cam 1206 rolling on the first bearing surface 1207 is spherical.

FIGS. 22 and 24 highlight the existence of a contact angle between on the one hand, the straight line connecting the contact points of the supporting cam 1206 on the first and the second bearing surface 1207 and 1208 and on the other hand, the straight line passing through the contact point of the supporting cam 1206 on the first bearing surface 1207 and through the centre of the spherical portion of the supporting cam 1206. A first projection of said contact angle on a principal plane appears in FIG. 22, this first projection being equal to the insertion angle α. A second projection of said contact angle on a secondary plane appears in FIG. 24, this second projection being equal to the holding angle β. The existence of these two projections of the contact angle allow the blocking element 1201 to move along the insertion direction and along the holding direction, while the first and second bearing surfaces 1207 and 1208 remain essentially parallel.

The profile of the supporting cams 1206 allows an insertion angle α and a holding angle β that may vary when the blocking element 1201 moves along the insertion direction, or along the holding direction. Furthermore, the geometry of the supporting cams 1206 allows the blocking element 1201 to be capable of moving along two holding directions essentially symmetrical in relation to a principal plane passing through the centre of the gripping means 1200.

Advantageously, the insertion angle α and holding angle β are arranged in such a way as to allow the blocking element 1201 to be jammed between the first bearing surface 1207 and the driving surface 1204 for any winding force exerted by the link 1205 on the blocking element 1201. The condition for which the angles α and β are jamming angles of the blocking element 1201 for any winding force depends on the profile of the supporting cams 1206. For example, if this profile has angles α and β that are equal and constant, and if the coefficient of adhesion between the gripping surface 1203 and the driving surface 1204 is μ=0.1, if we neglect the coefficient of rolling of the supporting cams 1206, the jamming of the blocking element 1201 for any winding force is obtained for any α, β≤4.3°. It is also possible to have α≠β as well as non-constant a and p when the blocking element 1201 moves along the first bearing surface 1207.

FIG. 22 shows the movement of the blocking element 1201 and the supporting cams 1206 along the insertion direction.

FIG. 24 shows the movement of the blocking element 1201 and the supporting cams 1206 along the holding direction.

Advantageously, the supporting cams 1206, the first and second bearing surface 1207 and 1208 may be partially or totally toothed to ensure synchronisation of the supporting cams 1206 and the blocking element 1201. Such a synchronisation may also be obtained by recentering the blocking element 1201 and the supporting cams 1206 using return springs when the gripping means is located outside the wound portions.

In this embodiment, the movement of the blocking element 1201 is along an insertion direction and along a holding direction. In the case where the actuating means is a shoe belonging to a blocking element 1201 on which the transmission link 1205 comes in contact along the principal direction, then said actuating shoe forms a mechanical obstacle to the component along the principal direction of the winding force of the transmission link 1205. In this case, it is not necessary for the insertion angle α to be a jamming angle of the blocking element for the component along the principal direction of the winding force. It is sufficient that the holding angle β is a jamming angle for the component along the secondary direction of the winding force to allow the blocking element to transmit the components along the principal and secondary directions of the winding force to the wheel.

FIG. 25 shows an example of a supporting cam 1206 comprising a synchronism set of teeth.

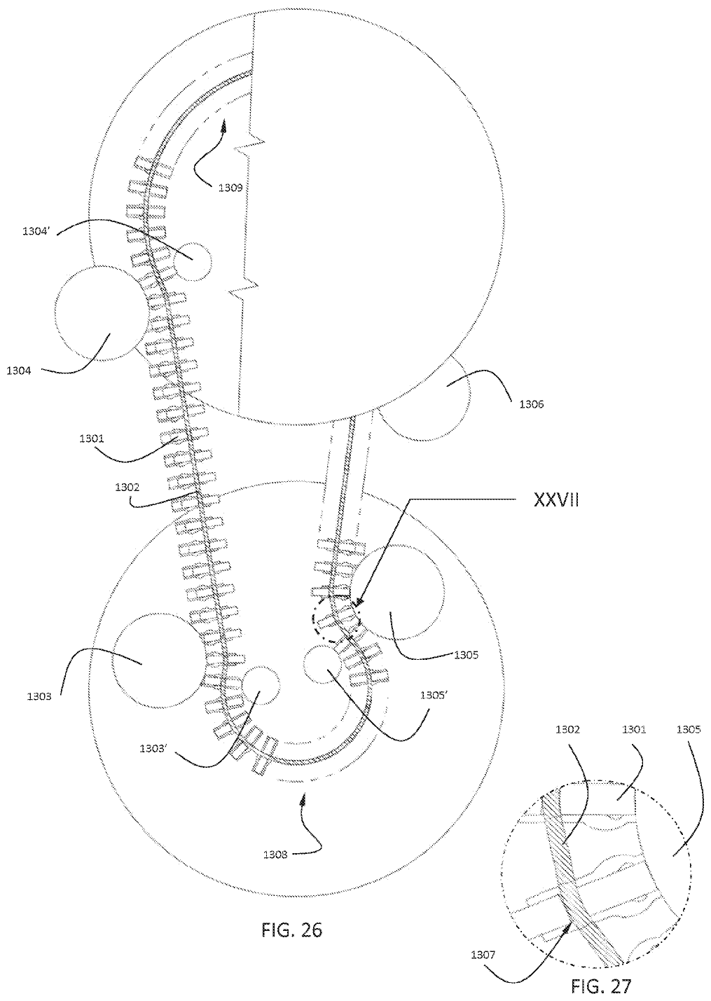

FIG. 26 and FIG. 27 show an embodiment in which the actuating means is constituted of an actuating cable 1302 circulating in grooves 1307 belonging to the blocking elements 1301 and actuating rollers 1303, 1303′, 1304, 1304′, 1305, 1305′, 1306. For the sake of clarity, certain elements such as, for example, articulation movers or even the pulling chain have not been shown.

Due to its tension, the actuating cable 1302 extends in portions that are essentially straight between the supporting points formed by the blocking elements 1301 cooperating with the actuating rollers 1303, 1303′, 1304, 1304′, 1305, 1305′, 1306. The blocking elements 1301 being linked to the actuating cable 1302 by means of their groove 1307, they follow the trajectory of said actuating cable 1302 which, with the actuating rollers 1303, 1303′, 1304, 1304′, 1305, 1305′, 1306 thus constitutes an actuating means capable of driving the blocking elements 1301 towards the nominal position when they enter into a wound position 1308, 1309. Said actuating cable 1302 and the actuating rollers also constitute a return means capable of bringing the blocking element 1301 back towards its minimum position when it leaves a rolled portion 1308, 1309.

In a variation, when the blocking elements 1301 are located in a straight cable, the actuating cable 1302 departs axially from the grooves 1307 belonging to said blocking elements 1301 and it rolls on a means for tensioning the actuating cable.

As this is shown in FIGS. 26 and 27, the actuating rollers 1305, 1306 may also be used as a means of tensioning the transmission link.

1. Auto-locking gripping means (20, 21, 400, 410, 50, 51, 61, 70, 71, 80, 81, 90, 91, 1000, 1100, 1110, 1200) for a continuously variable transmission mechanism (1) comprising at least one wheel (3, 4, 700) and a transmission link (2, 602, 72, 1205) extending in a closed loop and cooperating with said wheel along a wound portion (35, 45), the transmission link being constituted of a succession of link portions each defining a longitudinal direction (L) tangent to the closed loop and a normal direction (N) perpendicular to a longitudinal plane, parallel to the rotation axis of the wheel and to the longitudinal direction (L),
characterised in that the gripping means comprises at least one gripping support (22, 420, 52, 82, 92, 612, 702, 712, 1002, 1102, 1202) having at least one first bearing surface (215, 5014, 5015, 615, 804, 805, 814, 815, 903, 1003, 1103, 1207) and at least one blocking element (201, 211, 301, 401, 5010, 5011, 611, 701, 711, 801, 811, 901, 911, 1001, 1101, 1111, 1201) comprising:
a second bearing surface (216, 806, 816, 904, 1104, 1208) cooperating with the first bearing surface, by a sliding or rolling contact,
a gripping surface (213, 203, 5018, 5019, 1005, 1112, 1113, 1203), capable of cooperating temporarily with a facing driving surface (43, 44, 613, 1204), belonging to the wheel when the gripping means is integral with the transmission link, and belonging to the transmission link when the gripping means is integral with the wheel,
said blocking element being capable of moving along the first bearing surface at least along one insertion direction (I) comprised in a principal plane passing through the blocking element, said principal plane being parallel to the rotation axis of the wheel and to a principal direction (P), which passes through the blocking element, which is radial when the gripping means is integral with the wheel and which is normal when the gripping means is integral with a portion of the link, said movement of the blocking element along the insertion direction having a minimum position in which the gripping surface is the furthest from the facing driving surface and a nominal position in which the gripping surface is in contact with the driving surface, the insertion direction having a non-zero insertion angle (α) relatively to the principal direction.

2. Gripping means (20, 21, 400, 410, 50, 51, 61, 70, 71, 80, 81, 90, 91, 1000, 1100, 1110, 1200) according to claim 1, characterised in that the insertion angle (α) is arranged such as to allow the blocking element (201, 211, 301, 401, 5010, 5011, 611, 701, 711, 801, 811, 901, 911, 1001, 1101, 1111, 1201), when it is located in a wound portion (35, 45), to be jammed between the first bearing surface (215, 5014, 5015, 804, 805, 814, 815, 903, 1003, 1103, 1207, 615) and the driving surface (43, 44, 613, 1204) when the driving surface exerts on the facing gripping surface (213, 203, 5018, 5019, 1005, 1112, 1113, 1203) a force whose projection in a plane normal to the rotation axis of the wheel (3, 4, 700) is only along the principal direction (P).

3. Gripping means (20, 21, 400, 410, 61, 70, 71, 80, 81, 90, 91, 1000) according to claim 1, characterised in that the insertion angle (α) is arranged in such a way as to allow the blocking element (201, 211, 301, 401, 611, 701, 711, 801, 811, 901, 911, 1001), when it is located in a wound portion (35, 45) to be jammed between the first bearing surface (215, 615, 804, 805, 814, 815, 903, 1003) and the driving surface (43, 44, 613) when the driving surface exerts on the facing gripping surface (213, 203, 1005) a force whose projection in a plane normal to the rotation axis of the wheel (3, 4, 700) has a first component along the principal direction (P) and a second component along a secondary direction (S) perpendicular to the principal direction and to the rotation axis of the wheel, said second component having a magnitude changing proportionally to the magnitude of said first component.

4. Gripping means (50, 51, 1100, 1110, 1200) according to claim 1, characterised in that the blocking element (5010, 5011, 1101, 1111, 1201) is capable of moving along the first bearing surface (5014, 5015, 1103, 1207) along a second direction which is a holding direction (T, T1, T2) comprised in a secondary plane perpendicular to the principal direction (P), said holding direction having a non-zero holding angle (β) relatively to the secondary direction (S).

5. Gripping means (50, 51, 1100, 1110, 1200) according to claim 4, characterised in that it comprises at least one blocking element (5010, 5011, 1101, 1111, 1201) capable of moving at least temporarily along a holding direction (T1) and at least one blocking element capable of moving at least temporarily along a second holding direction (T2) essentially symmetrical to said holding direction relatively to a principal plane passing essentially through the centre of the gripping support (52, 1102, 1202).

6. Gripping means (50, 51, 1100, 1110, 1200) according to claim 4, characterised in that the holding angle (β) is arranged such as to allow the blocking element (5010, 5011, 1101, 1111, 1201), when it is located in a wound portion (35, 45), to be jammed between the first bearing surface (5014, 5015, 1103, 1207) and the driving surface (43, 44, 1204) when the driving surface exerts on the facing gripping surface (5018, 5019, 1112, 1113, 1203) a force whose projection in a plane normal to the rotation axis of the wheel (3, 4) is only along the principal direction (S).

7. Gripping means (50, 51, 1100, 1110, 1200) according to claim 4, characterised in that it comprises at least one blocking element (5010, 5011, 1101, 1111, 1201) capable of moving along any combination of an insertion direction (I) and a holding direction (T, T1, T2), the insertion and holding angles being arranged in such a way as to allow the blocking element, when it is located in a wound portion (35, 45), to be jammed between a first bearing surface (5014, 5015, 1103, 1207) and a driving surface (43, 44, 1204) when the driving surface exerts on the facing gripping surface (5018, 5019, 1112, 1113, 1203) a force whose projection on a plane normal to the rotation axis of a wheel (3, 4) has a component along the principal direction (P) and a component along the secondary direction (S).

8. Transmission mechanism (1) characterised in that it comprises at least one gripping means (20, 21, 400, 410, 50, 51, 61, 70, 71, 80, 81, 90, 91, 1000, 1100, 1110, 1200) according to claim 1, and at least one return means (205, 505, 515, 605, 705, 715, 83-807-817, 902, 912) capable of moving the blocking element (201, 211, 301, 401, 5010, 5011, 611, 701, 711, 801, 811, 901, 911, 1001, 1101, 1111, 1201) towards the minimum position.

9. Transmission mechanism (1) according to claim 8, characterised in that it comprises at least one actuating means capable of moving the blocking element (201, 211, 301, 401, 5010, 5011, 611, 701, 711, 801, 811, 901, 911, 1001, 1101, 1111, 1201, 1302, 1303′, 1304, 1304′, 1305, 1305′, 1306) towards the nominal position.

10. Transmission mechanism (1) according to claim 9, characterised in that the gripping support (612) is radially movable along a groove (603) belonging to a flange (600, 601) of a wheel.

11. Transmission mechanism (1) according to claim 9 characterised in that the actuating means is an actuating shoe (506, 516, 614) which is linked to the blocking element (5010, 5011, 611, 1201) and which is intended to cooperate with the transmission link (602, 1205) when the gripping means (61, 1200) is integral with a flange (600, 601) of a wheel and which is intended to cooperate with a wheel (3, 4) when the gripping means (50, 51) is integral with a portion of the link.

12. Transmission mechanism (1) according to claim 9 characterised in that the actuating means comprises an actuating pad (204, 214, 304, 717) linked to the blocking element (201, 211, 301, 701, 711) and an actuating cam (5, 714) cooperating with said actuating pad, the actuating cam being integral with an articulation mover (7).

13. Transmission mechanism (1) according to claim 12, characterised in that the articulation mover (7) is capable of pivoting about a rotation axis of a wheel (3, 4, 700) and has a means of angular positioning at least relatively to the strand of the transmission link (2, 72) comprising the portions of the link which, in the direction of travel of the transmission link, will cooperate with said wheel.

14. Transmission mechanism (1) according to claim 12, characterised in that the actuating cam (5) is linked to the articulation mover (7) by an actuator (11) capable of changing the radial position of the actuating cam.
